(19) United States
(12) Patent Application Publication
(10) Pub. No.: US 2019/0030898 A1
(43) Pub. Date: Jan. 31, 2019

(54) JETTING-MODULE CLEANING SYSTEM WITH ROTATING WIPER MECHANISM

(71) Applicant: Eastman Kodak Company, Rochester, NY (US)

(72) Inventors: Michael J. Piatt, Dayton, OH (US); Jeffrey L. Roberts, Beavercreek, OH (US); Bruce Anthony Bowling, Beavercreek, OH (US)

(21) Appl. No.: 15/660,000

(22) Filed: Jul. 26, 2017

(51) Int. Cl. B41J 2/165

(52) U.S. Cl. CPC B41J 2/16535

(57) ABSTRACT

A jetting-module cleaning system for cleaning the nozzle plate of a jetting module includes a rotating wiper mechanism. The rotating wiper mechanism includes a rotating sleeve having one or more outlet openings extending from its hollow core to its outer surface, and one or more wiper blades. A pressurized fluid source supplies pressurized cleaning fluid to the hollow core of the rotating sleeve. An actuator rotates the rotating wiper mechanism around its axis. A valve is controlled so that cleaning fluid is sprayed onto the nozzle plate through the outlet openings when the rotating wiper mechanism is rotated to an angular orientation where the outlet openings face the nozzle plate.

### CROSS REFERENCE TO RELATED APPLICATIONS

Reference is made to commonly assigned, co-pending U.S. patent application Ser. No. ______ (Docket K002160), entitled: “Jetting module cleaning system with rotating wiper mechanism,” by M. Piatt et al., which is incorporated herein by reference.

### FIELD OF THE INVENTION

This invention pertains to the field of inkjet printing and more particularly to a system for cleaning inkjet jetting modules.

### BACKGROUND OF THE INVENTION

The jetting modules in inkjet printers (both drop-on-demand printing systems and continuous inkjet printing systems) can occasionally suffer from deposits, either within a nozzle or on the exterior of the nozzle plate, that can obstruct or alter the flow of ink through one or more nozzles. It is therefore desirable to provide a system for removing such deposits. In drop-on-demand printing systems, various cleaning mechanisms have been used, such as the wiping of an elastomeric blade across the nozzle plate.

In continuous inkjet printing systems, the printheads in general are constructed with drop selection components (charging electrodes, deflection electrodes, and catchers) in close alignment with the nozzle array of the jetting module. The close alignment of the drop selection components with the nozzle array of the jetting module has, to a large degree, precluded the use of wiper blades for the removal of debris from the nozzle plates of the continuous inkjet printheads. The tight tolerance associated with the alignment of these components has also precluded the dismounting of the jetting module from the drop selection portion of the printhead so that it can be cleaned, and then reinserting the jetting module back into the printhead. Due to these constraints, prior art continuous inkjet printing systems have typically relied on cross-flushing fluid through the jetting module, together with modulating the ink pressure in the jetting module, so as to produce both outward and inward flow of ink or a cleaning fluid through the nozzles, as disclosed in U.S. Pat. No. 4,591,873 to McCann et al. Frequently ultrasonic energy is applied to the jetting module to further aid in removing dried ink or other debris from the nozzles, as disclosed in U.S. Pat. No. 4,563,688 to Braun.

With the introduction of more permanent pigmented inks, there is a need for improved cleaning systems and methods for use in continuous inkjet printing systems.

### SUMMARY OF THE INVENTION

The present invention represents a jetting-module cleaning system for cleaning ink deposits from a nozzle plate of a jetting module of an inkjet printing system, the nozzle plate including an array of nozzles through which ink is ejected, the array of nozzles extending a length in a length direction, including:

a mounting system for mounting the jetting module in the jetting-module cleaning system;

a rotating wiper mechanism including:

a rotating sleeve which rotates around a sleeve axis, the rotating sleeve having a hollow core and an outer surface, the sleeve axis being parallel to the length direction of the nozzle array of a mounted jetting module, the rotating sleeve having a length which is at least as long as the length of the nozzle array, wherein the rotating sleeve includes a set of one or more outlet openings extending from the hollow core to the outer surface, the outlet openings being located at an angular position relative to the sleeve axis; and

one or more wiper blades affixed to the outer surface of the rotating sleeve at corresponding angular positions, the wiper blades extending the length of the nozzle array, wherein when the rotating sleeve is rotated the wiper blades wipe across the nozzle pate of the mounted jetting module;

an actuator for rotating the rotating wiper mechanism around the sleeve axis;

a pressurized fluid source for supplying pressurized cleaning fluid through tubing to the hollow core of the rotating sleeve; and

a valve adapted to control the flow of the cleaning fluid through the tubing between the pressurized fluid source and the hollow core of the rotating sleeve;

wherein when the rotating wiper mechanism is rotated to an angular orientation where the one or more outlet openings in the rotating sleeve face the nozzle plate the valve is controlled to enable the flow of the cleaning fluid through the tubing so that the cleaning fluid is sprayed onto the nozzle plate, and when the rotating wiper mechanism is rotated to an angular orientation where the one or more outlet openings in the rotating sleeve do not face the nozzle plate the valve is controlled to block the flow of the cleaning fluid through the tubing.

This invention has the advantage that the spraying of cleaning fluid onto the nozzle plate in combination with a wiping action reduces the risk of scratching the nozzle plate when compared to wiper only system and reduces the consumption of cleaning fluid when compared to spraying only systems. The co-locating of the spraying system with the rotating wiper assembly, provides a compact cleaning system. The use of the same mounting features for mounting the jetting module in the cleaning system as are used for mounting the jetting module in the printhead ensures a consistent positioning of the nozzle array on the nozzle plate relative to the spraying system and rotating wiper assembly for improved consistency of cleaning.

It has the additional advantage that the cleaning system can be positioned adjacent to a linehead such that a jetting module can be conveniently dismounted from the linehead and mounted in the cleaning system without the need to disconnect the fluid and electrical connections to the jetting module. This allows the spraying and wiping function of the cleaning system be used synergistically with the cleaning functions incorporated the printing system.

### BRIEF DESCRIPTION OF THE DRAWINGS

FIG. 1 is a simplified block schematic diagram of an exemplary continuous inkjet system in accordance with the present invention;

FIG. 2 shows an image of a liquid jet being ejected from a drop generator and its subsequent break off into drops with a regular period;

FIG. 3 shows a cross sectional of an inkjet printhead of the continuous liquid ejection system in accordance with the present invention;

FIG. 4 shows a first example embodiment of a timing diagram illustrating drop formation pulses, the charging electrode waveform, and the break-off of drops;

FIG. 5 shows a schematic plan view of a jetting-module cleaning system according to an exemplary embodiment;

FIG. 6 shows a schematic plan view of the jetting-module cleaning system of FIG. 5 with the jetting module removed to show additional details;

FIG. 7 shows a schematic cross-sectional view of the jetting-module cleaning system of FIG. 5;

FIG. 8 shows an enlarged view of a portion of FIG. 7;

FIG. 9 shows an enlarged view of a portion of FIG. 6;

FIG. 10 shows a view corresponding to that of FIG. 9 for another exemplary embodiment of the invention;

FIG. 11 shows a view corresponding to that of FIG. 9 for another exemplary embodiment of the invention;

FIG. 12 shows a view corresponding to that of FIG. 8 where the rotating wiper is rotated to an orientation where the wiper blades are rinsed by immersion into the cleaning fluid;

FIG. 13 shows a schematic isometric view of a portion of the jetting-module cleaning system of FIG. 5, with the mounting plate removed to show additional details;

FIG. 14 shows a view corresponding to that of FIG. 8 for another exemplary embodiment of the invention;

FIG. 15 shows a view corresponding to that of FIG. 9 for the exemplary embodiment of FIG. 14;

FIG. 16 shows a schematic of a jetting-module cleaning system showing features of an exemplary fluid source;

FIG. 17 shows a schematic plan view of a portion of a printing system including a jetting-module cleaning system; and

FIG. 18 shows a schematic cross-sectional view of a jetting-module cleaning system adapted for use with jetting modules having an alternate mounting system.

It is to be understood that the attached drawings are for purposes of illustrating the concepts of the invention and may not be to scale. Identical reference numerals have been used, where possible, to designate identical features that are common to the figures.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

The example embodiments of the present invention are illustrated schematically and not to scale for the sake of clarity. One of the ordinary skills in the art will be able to readily determine the specific size and interconnections of the elements of the example embodiments of the present invention.

As described herein, the example embodiments of the present invention provide a printhead or printhead components typically used in inkjet printing systems. However, many other applications are emerging which use printheads to emit liquids (other than inks) that need to be finely metered and deposited with high spatial precision. These applications include application of medicinal compounds, application of materials for forming electronic components, application of catalytic materials for initiating electroless plating operations, and application of masking materials for shielding selective portions of a substrate for subsequent deposition or material removal processes, application of binder materials to layer of granular material for the forming of three dimensional structures. As such, as described herein, the terms “liquid” and “ink” refer to any material that can be ejected by the printhead or printhead components described below.

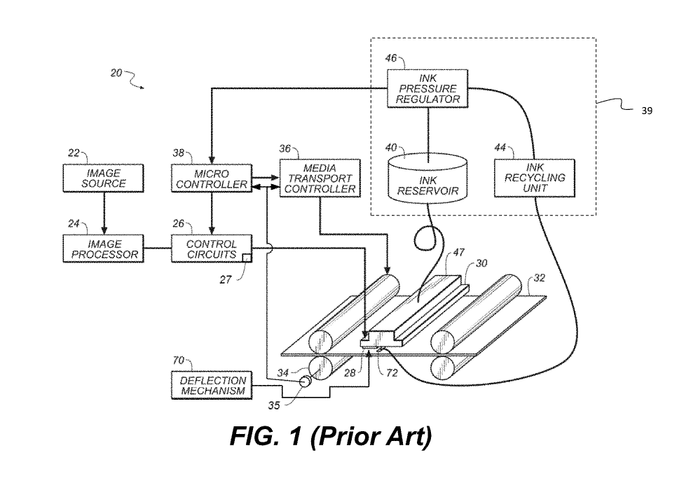

Referring to FIG. 1, a continuous printing system 20 includes an image source 22 such as a scanner or computer which provides raster image data, outline image data in the form of a page description language, or other forms of digital image data. This image data is converted to half-toned bitmap image data by an image processing unit (image processor) 24 which also stores the image data in memory. A plurality of drop forming transducer control circuits 26 reads data from the image memory and apply time-varying electrical pulses to a drop forming transducers 28 that are associated with one or more nozzles of a printhead 30. These pulses are applied at an appropriate time, and to the appropriate nozzles, so that drops formed from a continuous ink jet stream will form spots on a print medium 32 in the appropriate position designated by the data in the image memory.

Print medium 32 is moved relative to the printhead 30 by a print medium transport system 34, which is electronically controlled by a media transport controller 36 in response to signals from a speed measurement device 35. The media transport controller 36 is in turn is controlled by a micro-controller 38. The print medium transport system shown in FIG. 1 is a schematic only, and many different mechanical configurations are possible. For example, a transfer roller could be used in the print medium transport system 34 to facilitate transfer of the ink drops to the print medium 32. Such transfer roller technology is well known in the art. In the case of page width printheads, it is most convenient to move the print medium 32 along a media path past a stationary printhead. However, in the case of scanning print systems, it is often most convenient to move the printhead along one axis (the sub-scanning direction) and the print medium 32 along an orthogonal axis (the main scanning direction) in a relative raster motion.

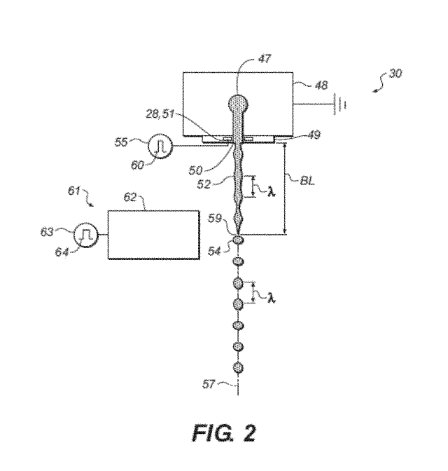

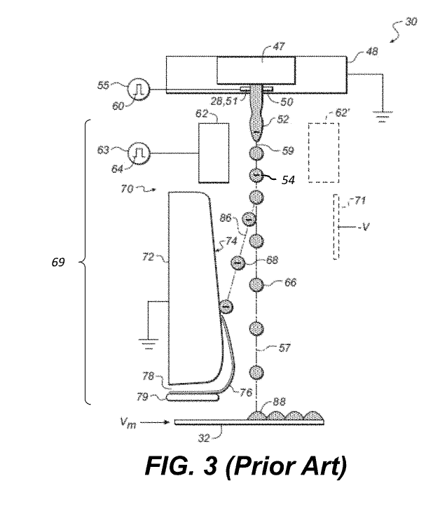

Ink is contained in an ink reservoir 40 under pressure. In the non-printing state, continuous ink jet drop streams are unable to reach print medium 32 due to an ink catcher 72 that blocks the stream of drops, and which may allow a portion of the ink to be recycled by an ink recycling unit 44. The ink recycling unit 44 reconditions the ink and feeds it back to the ink reservoir 40. Such ink recycling units are well known in the art. The ink pressure suitable for optimal operation will depend on several factors, including geometry and thermal properties of the nozzles and thermal properties of the ink. A constant ink pressure can be achieved by applying pressure to the ink reservoir 40 under the control of an ink pressure regulator 46. Alternatively, the ink reservoir can be left unpressurized, or even under a reduced pressure (vacuum), and a pump can be employed to deliver ink from the ink reservoir under pressure to the printhead 30. In such an embodiment, the ink pressure regulator 46 can include an ink pump control system. Collectively, the ink reservoir 40, the ink pressure regulator 46, and the ink recycling unit 44 is often referred to as the fluid system 39 of the inkjet printing system 20. The ink is distributed to the printhead 30 through an ink channel 47. The ink preferably flows through slots or holes etched through a silicon substrate of printhead 30 to its front surface, where a plurality of nozzles and drop forming transducers, for example, heaters, are situated. When printhead 30 is fabricated from silicon, the drop forming transducer control circuits 26 can be integrated with the printhead 30. The printhead 30 also includes a deflection mechanism 70 which is described in more detail below with reference to FIGS. 2 and 3.

Referring to FIG. 2, a schematic view of continuous liquid printhead 30 is shown. A jetting module 48 of printhead 30 includes an array of nozzles 50 formed in a nozzle plate 49. In FIG. 2, nozzle plate 49 is affixed to the jetting module 48. Alternatively, the nozzle plate 49 can be integrally formed with the jetting module 48. Liquid, for example, ink, is supplied to the nozzles 50 via liquid channel 47 at a pressure sufficient to form continuous liquid streams 52 (sometimes referred to as filaments) from each nozzle 50. In FIG. 2, the array of nozzles 50 extends into and out of the figure.

Jetting module 48 is operable to cause liquid drops 54 to break off from the liquid stream 52 in response to image data. To accomplish this, jetting module 48 includes a drop stimulation or drop forming transducer 28 (e.g., a heater, a piezoelectric actuator, or an electrohydrodynamic stimulation electrode), that, when selectively activated, perturbs the liquid stream 52, to induce portions of each filament to break off and coalesce to form the drops 54. Depending on the type of transducer used, the transducer can be located in or adjacent to the liquid chamber that supplies the liquid to the nozzles 50 to act on the liquid in the liquid chamber, can be located in or immediately around the nozzles 50 to act on the liquid as it passes through the nozzle, or can be located adjacent to the liquid stream 52 to act on the liquid stream 50 after it has passed through the nozzle 50.

In FIG. 2, drop forming transducer 28 is a heater 51, for example, an asymmetric heater or a ring heater (either segmented or not segmented), located in the nozzle plate 49 on one or both sides of the nozzle 50. This type of drop formation is known and has been described in, for example, commonly-assigned U.S. Pat. No. 6,457,807 (Hawkins et al.); U.S. Pat. No. 6,491,362 (Jeanmaire); U.S. Pat. No. 6,505,921 (Chwalek et al.); U.S. Pat. No. 6,554,410 (Jeanmaire et al.); U.S. Pat. No. 6,575,566 (Jeanmaire et al.); U.S. Pat. No. 6,588,888 (Jeanmaire et al.); U.S. Pat. No. 6,793,328 (Jeanmaire); U.S. Pat. No. 6,827,429 (Jeanmaire et al.); and U.S. Pat. No. 6,851,796 (Jeanmaire et al.), each of which is incorporated herein by reference.

Typically, one drop forming transducer 28 is associated with each nozzle 50 of the nozzle array. However, in some configurations, a drop forming transducer 28 can be associated with groups of nozzles 50 or all of the nozzles 50 in the nozzle array.

Referring to FIG. 2 the printing system has associated with it, a printhead 30 that is operable to produce, from an array of nozzles 50, an array of liquid streams 52. A drop forming device is associated with each liquid stream 52. The drop formation device includes a drop forming transducer 28 and a drop formation waveform source 55 that supplies a drop formation waveform 60 to the drop forming transducer 28. The drop formation waveform source 55 is a portion of the mechanism control circuits 26. In some embodiments in which the nozzle plate is fabricated of silicon, the drop formation waveform source 55 is formed at least partially on the nozzle plate 49. The drop formation waveform source 55 supplies a drop formation waveform 60 that typically includes a sequence of pulses having a fundamental frequency fₒ and a fundamental period of Tₒ=1/fₒ to the drop formation transducer 28, which produces a modulation with a wavelength λ, in the liquid jet. The modulation grows in amplitude to cause portions of the liquid stream 52 to break off into drops 54. Through the action of the drop formation device, a sequence of drops 54 is produced. In accordance with the drop formation waveform 60, the drops 54 are formed at the fundamental frequency fₒ with a fundamental period of Tₒ=1/fₒ. In FIG. 2, liquid stream 52 breaks off into drops with a regular period at break off location 59, which is a distance, called the break off length, BL from the nozzle 50. The distance between a pair of successive drops 54 is essentially equal to the wavelength λ of the perturbation on the liquid stream 52. The stream of drops 54 formed from the liquid stream 52 follow an initial trajectory 57.

The break off time of the droplet for a particular printhead can be altered by changing at least one of the amplitude, duty cycle, or number of the stimulation pulses to the respective resistive elements surrounding a respective resistive nozzle orifice. In this way, small variations of either pulse duty cycle or amplitude allow the droplet break off times to be modulated in a predictable fashion within ±one-tenth the droplet generation period.

Also, shown in FIG. 2 is a charging device 61 comprising charging electrode 62 and charging electrode waveform source 63. The charging electrode 62 associated with the liquid jet is positioned adjacent to the break off point 59 of the liquid stream 52. If a voltage is applied to the charging electrode 62, electric fields are produced between the charging electrode and the electrically grounded liquid jet, and the capacitive coupling between the two produces a net charge on the end of the electrically conductive liquid stream 52. (The liquid stream 52 is grounded by means of contact with the liquid chamber of the grounded drop generator.) If the end portion of the liquid jet breaks off to form a drop while there is a net charge on the end of the liquid stream 52, the charge of that end portion of the liquid stream 52 is trapped on the newly formed drop 54.

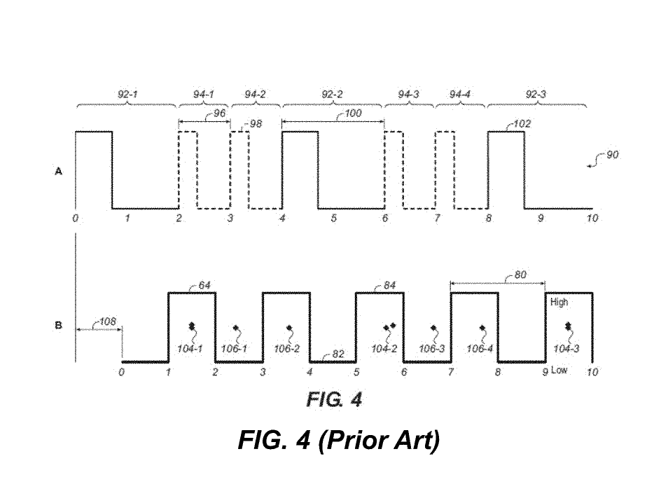

The voltage on the charging electrode 62 is controlled by the charging electrode waveform source 63, which provides a charging electrode waveform 64 operating at a charging electrode waveform 64 period 80 (shown in FIG. 4). The charging electrode waveform source 63 provides a varying electrical potential between the charging electrode 62 and the liquid stream 52. The charging electrode waveform source 63 generates a charging electrode waveform 64, which includes a first voltage state and a second voltage state; the first voltage state being distinct from the second voltage state. An example of a charging electrode waveform is shown in part B of FIG. 4. The two voltages are selected such that the drops 54 breaking off during the first voltage state acquire a first charge state and the drops 54 breaking off during the second voltage state acquire a second charge state. The charging electrode waveform 64 supplied to the charging electrode 62 is independent of, or not responsive to, the image data to be printed. The charging device 61 is synchronized with the drop formation device using a conventional synchronization device 27, which is a portion of the control circuits 26, (see FIG. 1) so that a fixed phase relationship is maintained between the charging electrode waveform 64 produced by the charging electrode waveform source 63 and the clock of the drop formation waveform source 55. As a result, the phase of the break off of drops 54 from the liquid stream 52, produced by the drop formation waveforms 92-1, 92-2, 92-3, 94-1, 94-2, 94-3, 94-4 (see FIG. 4), is phase locked to the charging electrode waveform 64. As indicated in FIG. 4, there can be a phase shift 108, between the charging electrode waveform 64 and the drop formation waveforms 92-1, 92-2, 92-3, 94-1, 94-2, 94-3, 94-4.

With reference now to FIG. 3, printhead 30 includes a drop forming transducer 28 which creates a liquid stream 52 that breaks up into ink drops 54. Selection of drops 54 as printing drops 66 or non-printing drops 68 will depend upon the phase of the droplet break off relative to the charging electrode voltage pulses that are applied to the to the charging electrode 62 that is part of the deflection mechanism 70, as will be described below. The charging electrode 62 is variably biased by a charging electrode waveform source 63. The charging electrode waveform source 63 provides charging electrode waveform 64, also called a charging electrode waveform 64, in the form of a sequence of charging pulses. The charging electrode waveform 64 is periodic, having a charging electrode waveform 64 period 80 (FIG. 4).

An embodiment of a charging electrode waveform 64 is shown in part B of FIG. 4. The charging electrode waveform 64 comprises a first voltage state 82 and a second voltage state 84. Drops breaking off during the first voltage state 82 are charged to a first charge state and drops breaking off during the second voltage state 84 are charged to a second charge state. The second voltage state 84 is typically at a high level, biased sufficiently to charge the drops 54 as they break off. The first voltage state 82 is typically at a low level relative to the printhead 30 such that the first charge state is relatively uncharged when compared to the second charge state. An exemplary range of values of the electrical potential difference between the first voltage state 82 and a second voltage state 84 is 50 to 300 volts and more preferably 90 to 150 volts.

Returning to a discussion of FIG. 3, when a relatively high level voltage or electrical potential is applied to the charging electrode 62 and a drop 54 breaks off from the liquid stream 52 in front of the charging electrode 62, the drop 54 acquires a charge and is deflected by deflection mechanism 70 towards the ink catcher 72 as non-print drops 68. The non-printing drops 68 that strike the catcher face 74 form an ink film 76 on the face of the ink catcher 72. The ink film 76 flows down the catcher face 74 and enters liquid channel 78 (also called an ink channel), through which it flows to the ink recycling unit 44. The liquid channel 78 is typically formed between the body of the catcher 72 and a lower plate 79.

Deflection occurs when drops 54 break off from the liquid stream 52 while the potential of the charging electrode 62 is provided with an appropriate voltage. The drops 54 will then acquire an induced electrical charge that remains upon the droplet surface. The charge on an individual drop 54 has a polarity opposite that of the charging electrode 62 and a magnitude that is dependent upon the magnitude of the voltage and the coupling capacitance between the charging electrode 52 and the drop 54 at the instant the drop 54 separates from the liquid jet. This coupling capacitance is dependent in part on the spacing between the charging electrode 62 and the drop 54 as it is breaking off. It can also be dependent on the vertical position of the breakoff point 59 relative to the center of the charge electrode 62. After the charge drops 54 have broken away from the liquid stream 52, they continue to pass through the electric fields produced by the charge plate. These electric fields provide a force on the charged drops deflecting them toward the charging electrode 62. The charging electrode 62, even though it cycled between the first and the second voltage states, thus acts as a deflection electrode to help deflect charged drops away from the initial trajectory 57 and toward the ink catcher 72. After passing the charging electrode 62, the drops 54 will travel in close proximity to the catcher face 74, which is typically constructed of a conductor or dielectric. The charges on the surface of the non-printing drops 68 will induce either a surface charge density charge (for a catcher face 74 constructed of a conductor) or a polarization density charge (for a catcher face 74 constructed of a dielectric). The induced charges on the catcher face 74 produce an attractive force on the charged non-printing drops 68. The attractive force on the non-printing drops 68 is identical to that which would be produced by a fictitious charge (opposite in polarity and equal in magnitude) located inside the ink catcher 72 at a distance from the surface equal to the distance between the ink catcher 72 and the non-printing drops 68. The fictitious charge is called an image charge. The attractive force exerted on the charged non-printing drops 68 by the catcher face 74 causes the charged non-printing drops 68 to deflect away from their initial trajectory 57 and accelerate along a non-print trajectory 86 toward the catcher face 74 at a rate proportional to the square of the droplet charge and inversely proportional to the droplet mass. In this embodiment, the ink catcher 72, due to the induced charge distribution, comprises a portion of the deflection mechanism 70. In other embodiments, the deflection mechanism 70 can include one or more additional electrodes to generate an electric field through which the charged droplets pass so as to deflect the charged droplets. For example, an optional single biased deflection electrode 71 in front of the upper grounded portion of the catcher can be used. In some embodiments, the charging electrode 62 can include a second portion on the second side of the jet array, denoted by the dashed line electrode 62′, which supplied with the same charging electrode waveform 64 as the first portion of the charging electrode 62.

In the alternative, when the drop formation waveform 60 applied to the drop forming transducer 28 causes a drop 54 to break off from the liquid stream 52 while the electrical potential of the charging electrode 62 is at the first voltage state 82 (FIG. 4) (i.e., at a relatively low potential or at a zero potential), the drop 54 does not acquire a charge. Such uncharged drops are unaffected during their flight by electric fields that deflect the charged drops. The uncharged drops therefore become printing drops 66, which travel in a generally undeflected path along the trajectory 57 and impact the print medium 32 to form a print dots 88 on the print medium 32, as the recoding medium is moved past the printhead 30 at a speed Vₘ. The charging electrode 62, deflection electrode 71 and ink catcher 72 serve as a drop selection system 69 for the printhead 30.

FIG. 4 illustrates how selected drops can be printed by the control of the drop formation waveforms supplied to the drop forming transducer 28. Section A of FIG. 4 shows a drop formation waveform 60 formed as a sequence that includes three drop formation waveforms 92-1, 92-2, 92-3, and four drop formation waveforms 94-1, 94-2, 94-3, 94-4. The drop formation waveforms 94-1, 94-2, 94-3, 94-4 each have a period 96 and include a pulse 98, and each of the drop formation waveforms 92-1, 92-2, 92-3 have a longer period 100 and include a longer pulse 102. In this example, the period 96 of the drop formation waveforms 94-1, 94-2, 94-3, 94-4 is the fundamental period Tₒ, and the period 100 of the drop formation waveforms 92-1, 92-2, 92-3 is twice the fundamental period, 2Tₒ. The drop formation waveforms 94-1, 94-2, 94-3, 94-4 each cause individual drops to break off from the liquid stream. The drop formation waveforms 92-1, 92-2, 92-3, due to their longer period, each cause a larger drop to be formed from the liquid stream. The larger drops 54 formed by the drop formation waveforms 92-1, 92-2, 92-3 each have a volume that is approximately equal to twice the volume of the drops 54 formed by the drop formation waveforms 94-1, 94-2, 94-3, 94-4.

As previously mentioned, the charge induced on a drop 54 depends on the voltage state of the charging electrode at the instant of drop breakoff. The B section of FIG. 4 shows the charging electrode waveform 64 and the times, denoted by the diamonds, at which the drops 54 break off from the liquid stream 52. The waveforms 92-1, 92-2, 92-3 cause large drops 104-1, 104-2, 104-3 to break off from the liquid stream 52 while the charging electrode waveform 64 is in the second voltage state 84. Due to the high voltage applied to the charging electrode 62 in the second voltage state 84, the large drops 104-1, 104-2, 104-3 are charged to a level that causes them to be deflected as non-printing drops 68 such that they strike the catcher face 74 of the ink catcher 72 in FIG. 3. These large drops may be formed as a single drop (denoted by the double diamond for 104-1), as two drops that break off from the liquid stream 52 at almost the same time that subsequently merge to form a large drop (denoted by two closely spaced diamonds for 104-2), or as a large drop that breaks off from the liquid stream that breaks apart and then merges back to a large drop (denoted by the double diamond for 104-3). The waveforms 94-1, 94-2, 94-3, 94-4 cause small drops 106-1, 106-2, 106-3, 106-4 to form. Small drops 106-1 and 106-3 break off during the first voltage state 82, and therefore will be relatively uncharged; they are not deflected into the ink catcher 72, but rather pass by the ink catcher 72 as printing drops 66 and strike the print media 32 (see FIG. 3). Small drops 106-2 and 106-4 break off during the second voltage state 84 and are deflected to strike the ink catcher 74 as non-printing drops 68. The charging electrode waveform 64 is not controlled by the pixel data to be printed, while the drop formation waveform 60 is determined by the print data. This type of drop deflection is known and has been described in, for example, commonly-assigned U.S. Pat. No. 8,585,189 (Marcus et al.); U.S. Pat. No. 8,651,632 (Marcus); U.S. Pat. No. 8,651,633 (Marcus et al.); U.S. Pat. No. 8,696,094 (Marcus et al.); and U.S. Pat. No. 8,888,256 (Marcus et al.), each of which is incorporated herein by reference.

These recent advances in continuous inkjet drop selection technology have greatly loosened the alignment tolerances between the components of the drop selection system 69 and the nozzle array on the jetting module 48, making it feasible to dismount the jetting module 48 from the drop selection components for cleaning and then to reinstall the jetting module 48 without the need for an involved alignment process. The new printhead designs also include kinematic alignment features, as described in commonly-assigned U.S. Pat. No. 8,226,215 (Bechler et al.), U.S. Pat. No. 7,819,501 (Hanchak et al.), U.S. Pat. No. 9,623,689 (Piatt et al.), and U.S. Pat. No. 9,527,319 (Brazas et al.), each of which is incorporated herein by reference, to enable consistent alignment of the jetting modules 48 to the drop selection hardware each time the jetting module 48 is removed and reinstalled. The present invention provides an improved cleaning system which is well-suited for use in such continuous inkjet systems.

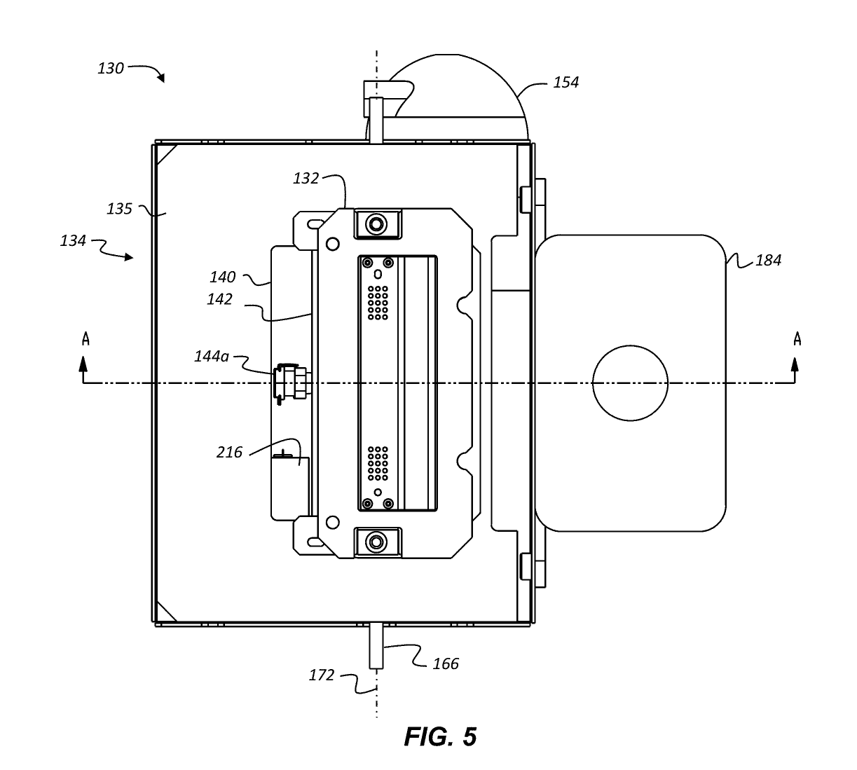

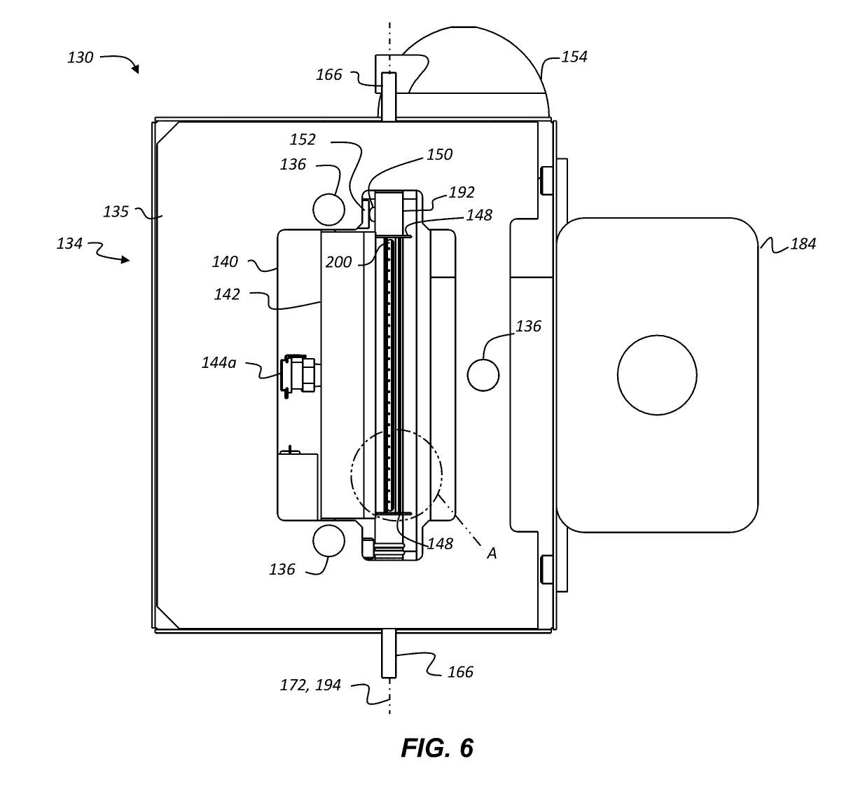

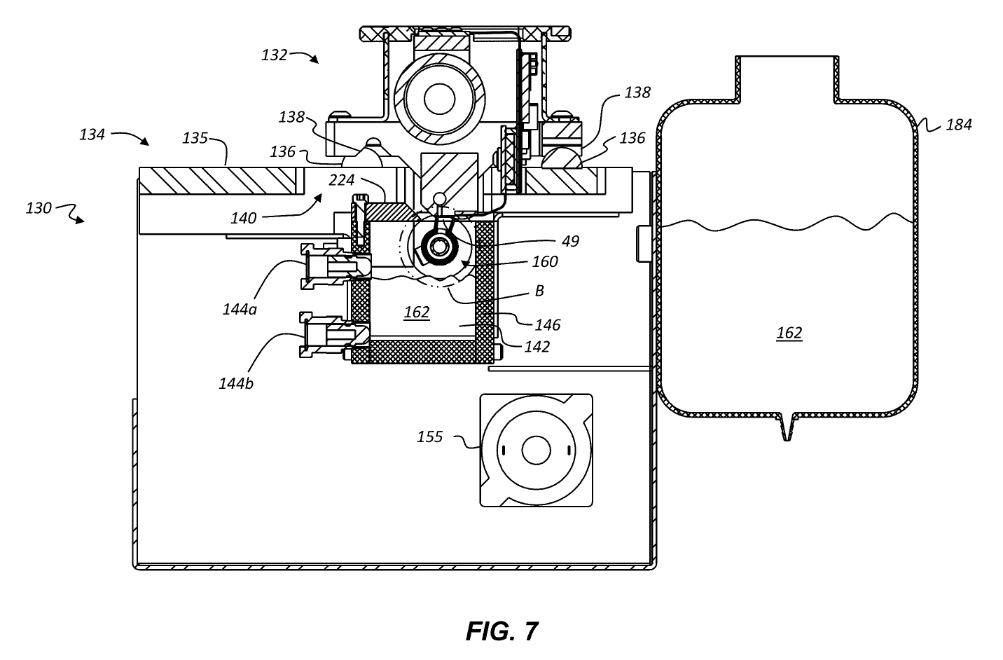

FIG. 5 shows a top view of a cleaning system 130, with a jetting module 132 installed on the cleaning system. FIG. 6 shows a similar view with the jetting module 132 removed. To ensure consistent alignment of the jetting module 132 relative to the cleaning mechanisms, the cleaning system 130 includes a mounting system 134 for mounting the jetting module 132. Preferably the mounting system 134 includes alignment features 136 that are similar to those used in the printing system for mounting and aligning the jetting module 132 in the printing system. The mounting system 134 shown in FIGS. 6-7 is like the jetting module mount disclosed in commonly-assigned U.S. Pat. No. 7,819,501, which is incorporated herein by reference. The mounting system 134 includes a mounting plate 135 having three alignment features 136, each in the form of a ball or hemisphere. These are engaged by alignment features 138 in the form of three V-grooves of the jetting module 132 to define the six degrees of freedom for the jetting module 132. This mounting system 134 ensures consistent placement for jetting module 132 relative to the cleaning components of the cleaning system 130.

Referring to FIG. 7 which is a cross-sectional view of the cleaning system 130, the cleaning system 130 includes sump 142 having walls 146, with a spraying system 160 located within the sump 142. The mounting plate 135 includes an opening 140 located above the sump 142. When a jetting module 132 is mounted on the cleaning system 130 using the mounting system 134, the face of the nozzle plate 49 of the jetting module 132 can be placed within the opening 140 facing the spraying system 160. The spraying system 160 is configured to spray a cleaning fluid 162 at the face of the nozzle plate 49 of the jetting module 132 to dissolve dried ink debris and to rinse contaminants off the face of the nozzle plate 49.

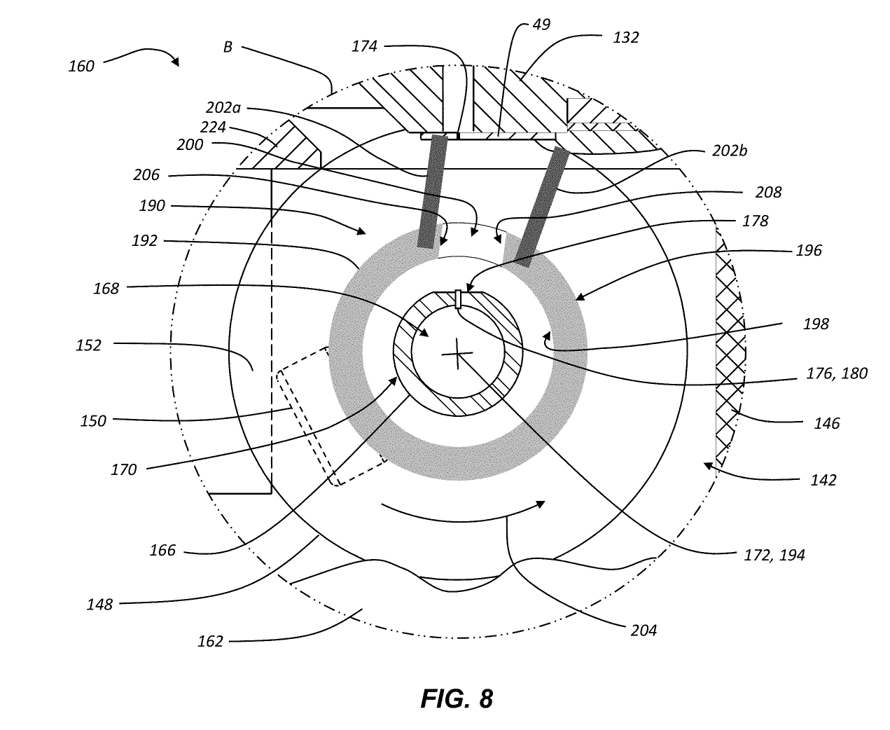

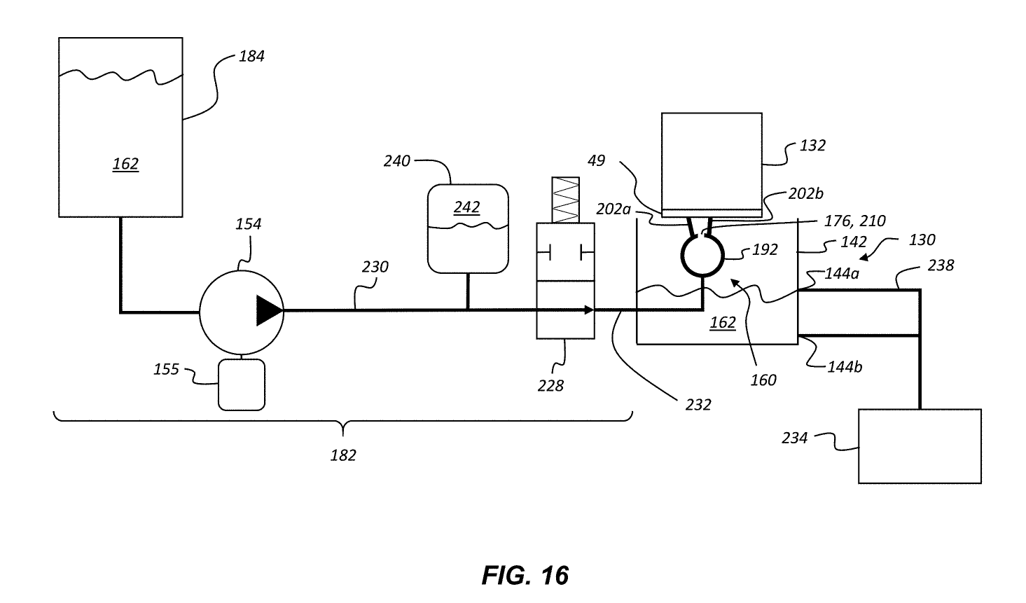

The spraying system 160 includes a non-rotating shaft 166 having a hollow core 168 and an outer surface 170, as shown in FIG. 8, which is a close-up view of the encircled region B of FIG. 7. The non-rotating shaft 166 has a shaft axis 172. The shaft axis 172 is oriented approximately parallel to the length direction of the nozzle array 174 of the jetting module 132. The non-rotating shaft 166 has a length which is at least as long as the length of the nozzle array 174, wherein the non-rotating shaft 166 includes one or more outlet openings 176 extending from the hollow core 168 to the outer surface 170, the one or more outlet openings 176 facing the nozzle plate 49. Tubing (not shown) is coupled to one or both ends of the non-rotating shaft 166 to fluidically connect the non-rotating shaft 166 to a fluid source 182 (see FIG. 16), which supplies cleaning fluid for spraying at the face of the nozzle plate 49. The fluid source will be described later. The hollow core 168 of the non-rotating shaft 166 serves as the plenum for distributing cleaning fluid 162 to each of the outlet openings 176.

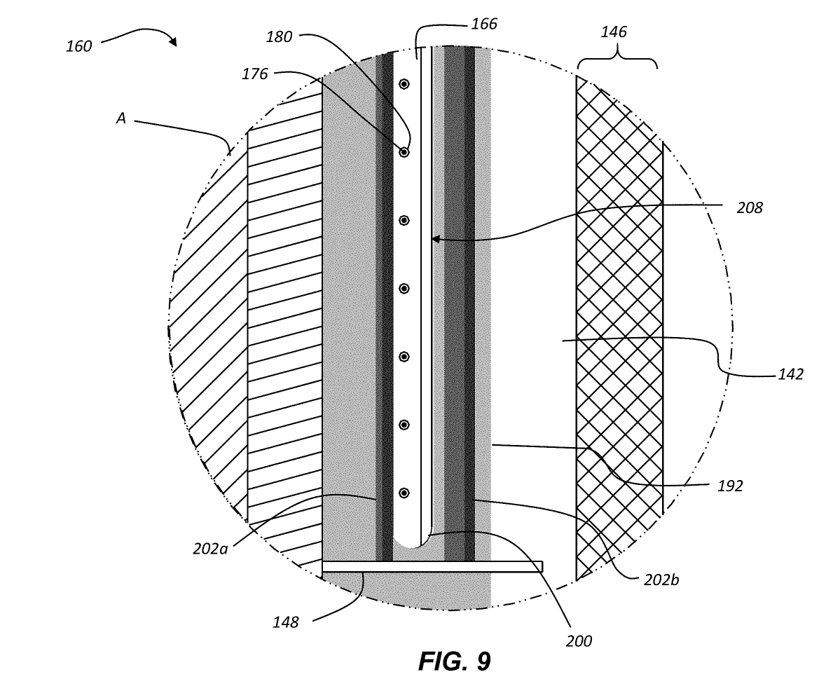

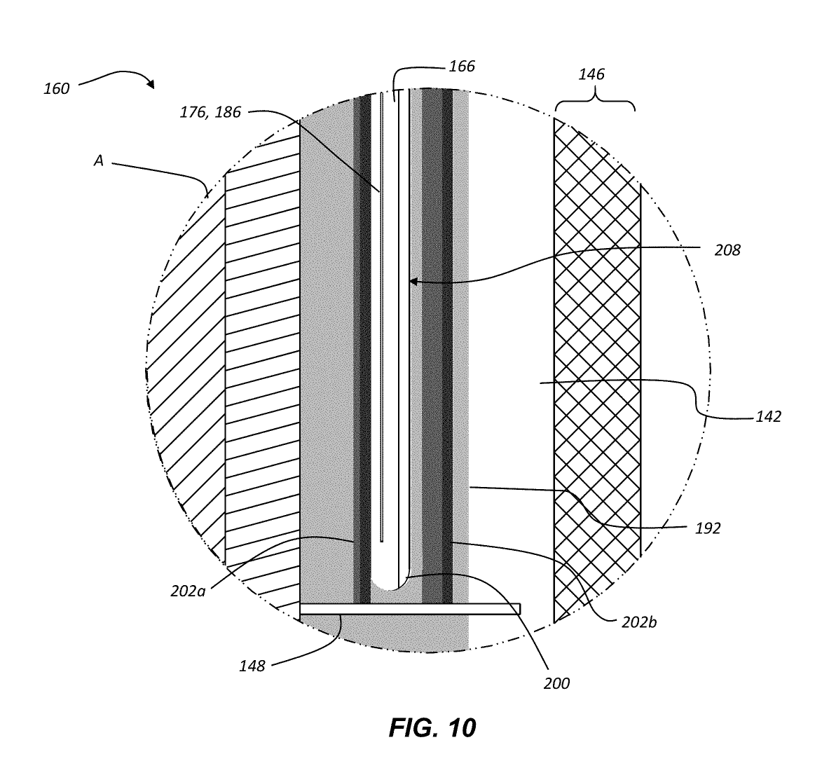

FIG. 9 is a close-up view of the encircled region A of FIG. 6, to show more detail of the outlet openings 176 in the non-rotating shaft 166. In a preferred embodiment, the non-rotating shaft 166 has an inside diameter of about 4.5 mm, but the inside diameter may vary depending on the length of the array of outlet openings 176, and on the desired flow rate of cleaning fluid 162 from each outlet opening 176. In a preferred embodiment, the outlet openings 176 are arranged in a line distributed along the length of the non-rotating shaft 166 with a spacing between outlet openings 176 of about 5 mm, the outlet openings 176 being circular nozzles having a diameter of approximately 0.1 mm. The size, spacing and number of outlet openings 176 however will depend on the application, and will vary depending on the construction of the nozzle plate 49 of the jetting module 132 and the specifics of the cleaning fluid 162 to be sprayed out of the outlet openings 176 onto the face of the nozzle plate 49. Note that “distributed along the length of the non-rotating shaft 166” does not necessarily imply that they span the full length of the non-rotating shaft 166. Preferably, the outlet openings span a length sufficient to insure that cleaning fluid 162 is sprayed over the entire length of the array of nozzles 50 in the nozzle plate 49. In some alternate embodiments, the one or more outlet openings 176 are in the form of a single elongated slot 186 extending in the length direction of the non-rotating shaft 166, as shown in FIG. 10.

Depending on the size of the outlet opening 176 for a particular application, the outlet openings 176 can be formed using a variety of processes, including conventional drilling, wire EDM, laser drilling the outlet openings through the wall of the non-rotating shaft 166, forming the outlet opening out of short pieces of hypodermic tubing 180 which are bonded into larger holes formed in the wall of the non-rotating shaft 166, or forming the outlet openings 176 in a polymeric or metallic foil which is bonded onto the non-rotating shaft 166 with the outlet openings 176 in fluid communication with one or more larger openings in the wall of the non-rotating shaft 166. To facilitate bonding of either the hypodermic tubing 180 or the polymeric and metallic foils to the non-rotating shaft 166, a portion of the outer surface 170 of the non-rotating shaft 166 can be machined to provide flat face 178. Cleaning fluid 162 for spraying at the nozzle plate 49 can be supplied by a pressurized fluid source 182 (see FIG. 16) to the hollow core 168 of the non-rotating shaft 166 through one or both ends of the non-rotating shaft 166. The fluid source 182 will be described in more detail later.

The cleaning system 130 also includes a rotating wiper mechanism 190. The rotating wiper mechanism 190 includes a hollow rotating sleeve 192 with one or more wiper blades 202a, 202b attached to its outer surface 196. The blades 202a, 202b are preferably elastomeric. The hollow rotating sleeve 192 is mounted in the cleaning system so that it can rotate about its sleeve axis 194 with the non-rotating shaft 166 mounted within the hollow rotating sleeve 192. The sleeve axis 194 is preferably coincident with the shaft axis 172.

The rotating sleeve 192 has one or more openings 200 extending through the wall of the rotating sleeve 192 from the inner surface 198 of the hollow rotating sleeve 192 to its outer surface 196. The one or more of the openings 200 extend along the length of the rotating sleeve 192 at a common angular position relative to the sleeve axis 194 such that the one or more of the openings 200 can align with the outlet openings 176 of the non-rotating shaft 166 at a corresponding angular orientation of the rotating sleeve 192. The one or more openings 200 extend along the length of the rotating sleeve 192 for a distance of at least the length of the array of the one or more outlet openings 176 in the non-rotating shaft 166.

In some embodiments (not shown), sets of one or more output openings 200 can be provided in the rotating sleeve 192 at a plurality of different angular positions. In this case, output openings 200 will align with the outlet openings 176 of the non-rotating shaft 166 at a plurality of different angular orientations of the rotating sleeve 192 to provide a plurality of cleaning cycles per revolution of the rotating sleeve 192. In such cases, wiper blades 202a, 202b will generally be provided adjacent to the angular positions of each set of outlet openings 200.

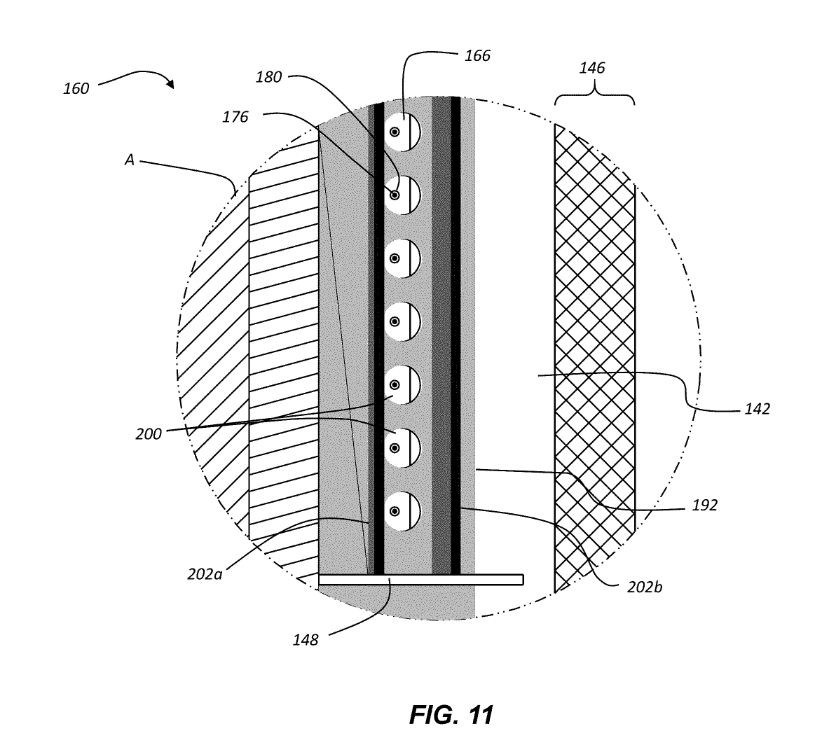

FIGS. 6, 9 and 10 show embodiments in which the rotating sleeve 192 has a single opening 200 that extends down the hollow rotating sleeve 192 to provide a single window through which each of the outlet openings 176 can spray cleaning fluid 162 at the nozzle plate 49. FIG. 11 shows an alternate embodiment in which the rotating sleeve 192 includes individual openings 200 which correspond with each of the outlet openings 176 of the non-rotating shaft 166.

Referring to FIG. 8, the wiper blades 202a, 202b are affixed to the outer surface 196 of the hollow rotating sleeve 192 at defined angular positions relative to the opening(s) 200 in the rotating sleeve 192. In a preferred embodiment, each of the wiper blades 202a, 202b extend at least the length of the nozzle array 174 and are parallel to the nozzle array 174. In an exemplary embodiment, two wiper blades 202a, 202a are attached to the rotating sleeve 192 adjacent to the leading edge 206 and the trailing edge 208, respectively, of the opening(s) 200 in the rotating sleeve 192. In the illustrated arrangement, the rotating sleeve 192 rotates in a counterclockwise direction 204. As the opening(s) 200 of the rotating sleeve 192 is rotated past the nozzle array 174, the leading edge 206 of the opening(s) 200 precedes the trailing edge 208 of the opening(s) 200 in being rotated past nozzle array 174. The wiper blade 202a adjacent to the leading edge 206 of the opening(s) 200 can be referred to as the leading wiper blade 202a, as it is affixed to the rotating sleeve 192 at an angular position preceding the angular position of the opening(s) 200. The wiper blade 202b adjacent to the trailing edge 208 of the opening(s) 200 can be referred to as the trailing wiper blade 202b, as it is affixed to the rotating sleeve 192 at an angular position following the angular position of the opening(s) 200. As the rotating wiper mechanism 190 is rotated, the spraying system 160 is configured to spray cleaning fluid 162 out of the outlet openings 176 of the non-rotating shaft 166 onto the nozzle plate 49 when the opening(s) 200 of the rotating sleeve 192 are aligned with the outlet openings 176 of the non-rotating shaft 166. To synchronize the spraying process with the angular position of the rotating sleeve 192, the cleaning system 130 can include a sensor for determining an angular orientation of the rotating sleeve 192. The sensing of the angular orientation can be carried out by any sensing means known in the art. FIG. 8 shows an exemplary configuration in which a Hall effect sensor 152 is used for detecting the magnetic fields produced by a magnet 150 attached to the rotating sleeve 192. Other useful types of sensors include rotary encoders attached to the rotating sleeve 192, capacitive proximity sensors for detection of a protrusion on the rotating sleeve 192, and cam follower switches.

As the rotating sleeve 192 is rotated, the leading wiper blade 202a wipes across the nozzle plate 49 prior to the spraying of cleaning liquid 162 onto the nozzle plate 49, and the trailing wiper blade 202b wipes across the nozzle plate 49 after the cleaning liquid 162 is sprayed on the nozzle plate 49. The cleaning liquid 162 sprayed at the nozzle plate 49 can dissolve deposits on the nozzle plate 49 to aid in their removal from the nozzle plate 49. Cleaning liquid 162 on the nozzle plate 49 also serves as a lubricant between the wiper blades 202a, 202b and the nozzle plate 49, reducing the risk of the wiper blades 202a, 202b abrading the nozzle plate 49.

Because the leading wiper blade 202a wipes across the nozzle plate 49 prior to the spraying of the cleaning liquid 162 on the nozzle plate 49, it is preferable for the wiping force of the leading wiper blade 202a against the nozzle plate 49 to be low to reduce the risk of abrading the nozzle plate 49. In a preferred embodiment, the wiping force of the leading wiper blade 202a against the nozzle plate is less than the wiping force of the trailing wiper blade 202b against the nozzle plate. In some embodiments, this is provided by using a leading wiper blade 202a that is shorter than the trailing wiper blade 202b, so that the leading wiper blade 202a undergoes less deformation than the trailing wiper blade 202b. In an exemplary configuration, the height of the leading wiper blade 202a is approximately 5.6 mm, while the trailing wiper blade has a height of 6.1 mm. In some embodiments, the leading wiper blade 202a is thinner or of a lower durometer than the trailing wiper blade 202b to provide a lower wiping force. Typically the wiper blades have a Shore A durometer in the range of 40-60.

In some embodiments, the tip of the un-deformed axis of the leading wiper blade 202a lags the base of the leading wiper blade 202a by a greater angular amount than does the tip of the un-deformed axis of the trailing wiper blade 202b behind the base of the trailing wiper blade 202b, as shown in FIG. 8, to thereby reduce the deformation of and the force applied by the leading wiper blade 202a relative to that of the trailing wiper blade 202b. This can reduce the deformation of and the force applied by the leading wiper blade 202a relative to that of the trailing wiper blade 202b. In the illustrated embodiment, the tip of the un-deformed trailing wiper blade 202b leads the base of the trailing wiper blade 202b.

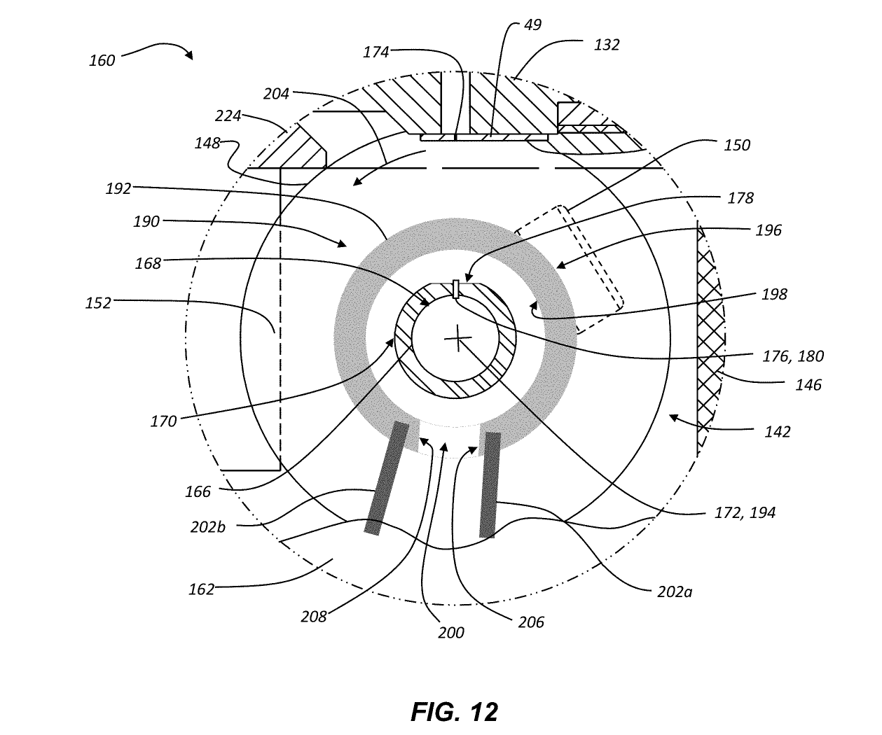

As the wiper blades 202a, 202b rotate they can dip into cleaning fluid 162 held in the sump 142 to rinse contaminants off the wiper blades 202a, 202b as shown in FIG. 12. As shown in FIG. 7, the sump 142 can include one or more ports 144a, 144b, through which cleaning fluid 162 can be removed from the sump 142. The upper port 144a, which can be connected to a waste fluid receptacle (not shown), serves as a skimmer drain through which cleaning fluid 162 can drain when the liquid depth in the sump 142 gets too high. Debris floating on the surface of the cleaning fluid 162 can exit the sump 142 through this port 144a. The height of the upper port 144a is preferably selected such that the tip of the wiper blades 202a, 202b can dip into the cleaning fluid 162. The lower port 144b is selectively coupled to the waste fluid receptacle to allow the all the cleaning fluid 162 to be drained from the sump 142.

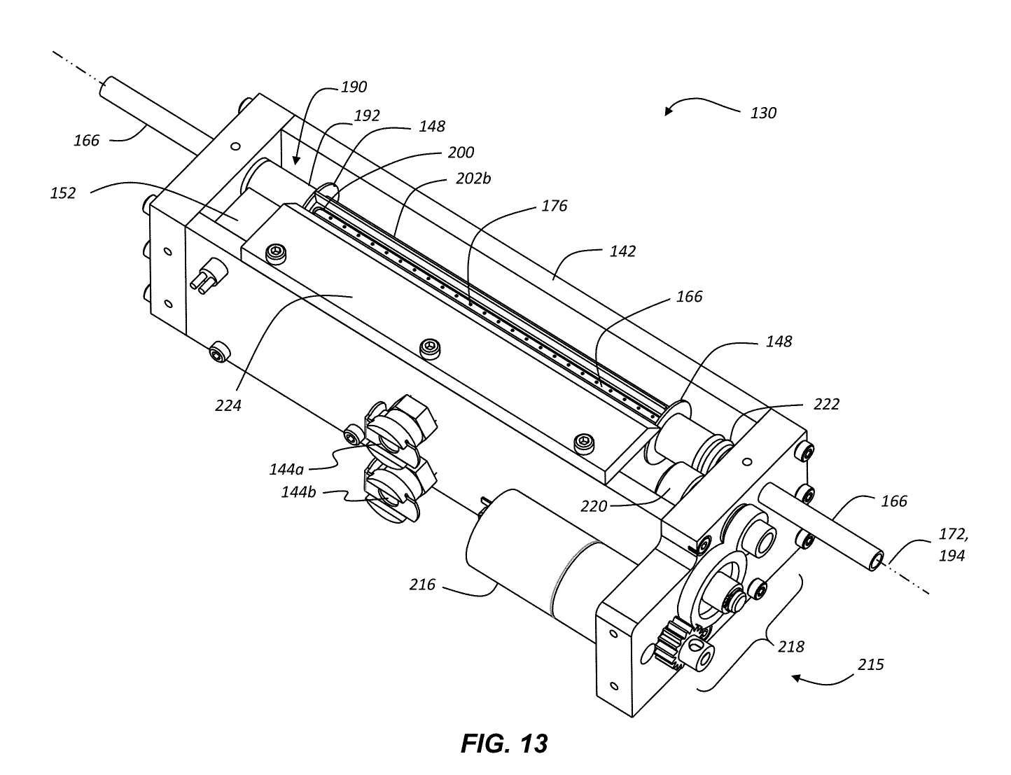

FIG. 13 shows an isometric view of a portion of the cleaning system 130, with the mounting system 134 (FIG. 4) removed to show the sump 142 and the actuator 215 which is used to rotate the rotating wiper mechanism 190. In this embodiment, the actuator 215 includes a motor 216 that is coupled to the rotating sleeve 192 via a set of gears 218 and a roller 220 that contacts rubber rings 222 affixed to the rotating sleeve 192. In other configurations, the motor 216 can be coupled to the rotating sleeve 192 using pulleys or various other gear or contact roller arrangements.

To reduce splash or spray, the cleaning system 130 can include an upper shield 224 positioned to the downstream side of the jetting module 132 (FIG. 7) relative to the rotation of the rotating sleeve 192. Additionally, side shields 148 positioned on the rotating sleeve 192 adjacent to each end of the jetting module 132 can limit the amount of lateral spray.

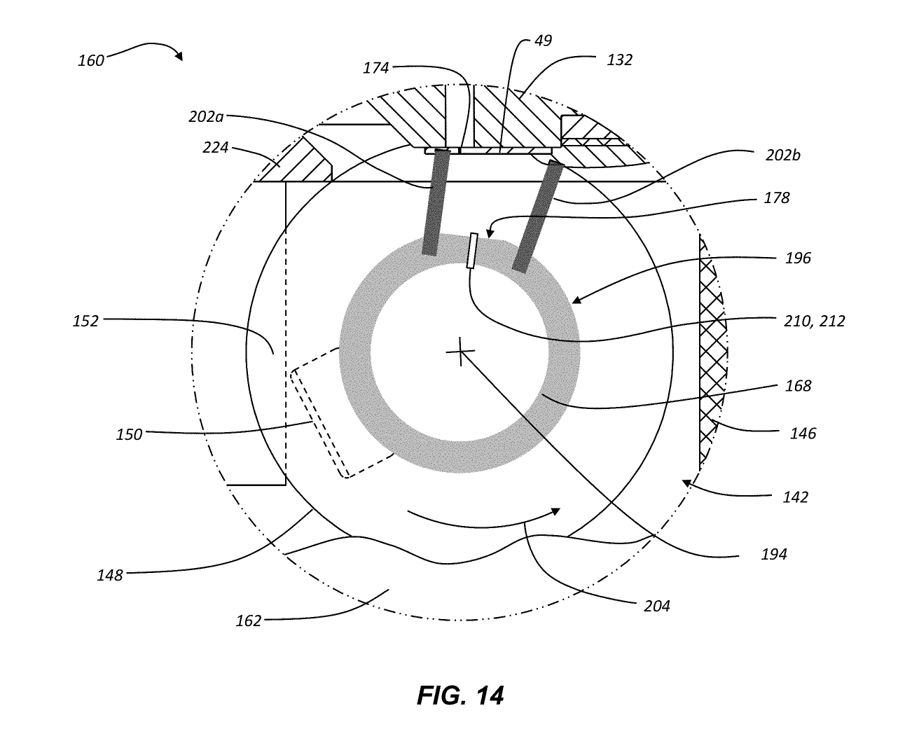

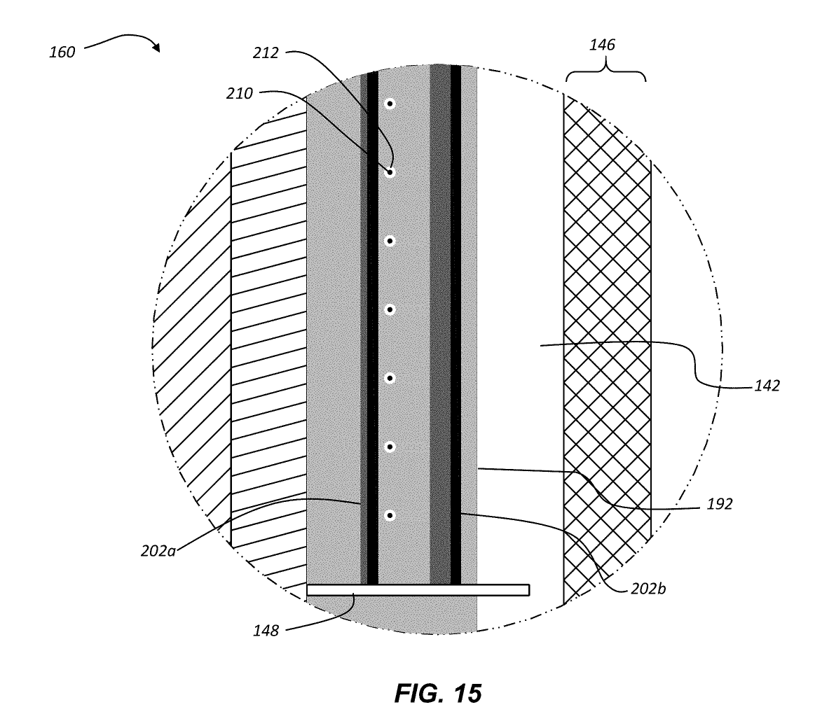

In an alternate embodiment illustrated in FIGS. 14 and 15, the hollow rotating sleeve 192 does not encircle a non-rotating shaft sprayer system. Instead, the rotating sleeve 192 includes a hollow core 168 and an outer surface 196, with one or more outlet openings 210 extending from the hollow core 168 to the outer surface 196. The one or more outlet openings 210 are located at a common angular position relative to the sleeve axis 194.

Depending on the size of the outlet openings 210 used for a particular application, the outlet openings 210 can be formed using a variety of processes including conventional drilling, wire EDM, or laser drilling the outlet openings through the wall of the rotating sleeve, forming the outlet opening out of short pieces of hypodermic tubing 212 which are bonded into larger holes formed in the wall of the rotating sleeve 192, or forming the outlet openings 210 in polymeric or metallic foil which is bonded onto the hollow rotating sleeve 192 with the outlet openings 210 in fluid communication with one or more larger openings in the wall of the hollow rotating sleeve 192. To facilitate bonding of either the hypodermic tubing 212 or the polymeric and metallic foils to the rotating sleeve 192 a portion of the outer surface 196 of the hollow rotating sleeve 192 can be machined to provide flat face 178. Cleaning fluid 162 for spraying at the nozzle plate can be supplied by a pressurized fluid source 182 (FIG. 16) to the hollow core 168 of the hollow rotating sleeve 192 through one or both ends of the hollow rotating sleeve 192.

FIG. 16 shown an embodiment of a fluid source 182 for the cleaning system 130. The fluid source 182 includes a reservoir 184 containing a supply of cleaning fluid 162. The fluid source 182 also includes a pump 154 operated by a pump motor 155 for supplying pressurized cleaning fluid 162 to the spraying system 160. In a preferred embodiment, the pump 154 is a peristaltic pump. Instead of only activating the pump 154 when the rotating sleeve 192 is rotated so that the outlet openings 176, 210 in the rotating sleeve 192 are facing the nozzle plate 49, the pump 154 is activated continuously during the cleaning process. A valve 228 is included in the fluid lines between the pump 154 and the sprayer system 160. This valve 228 is kept closed, blocking the fluid flow from the pump 154 except when cleaning fluid 162 is to be sprayed at the nozzle plate 49. With the pump 154 being continuously activated, when the valve 228 is closed the pump 154 becomes deadheaded and reaches its maximum output pressure. In an exemplary embodiment, the same motor 216 that drives the rotating wiper mechanism 190 is also used to drive the pump 154

In a preferred embodiment, the tubing 230 between the pump 154 and the valve 228 is compliant and has some elasticity, such that the tubing 230 can expand in response to the increase in fluid pressure. The expansion of the tubing 230 stores some of the fluid pressure energy. When the valve 228 is opened, the energy stored in the expanded tubing 230 is released to increase the velocity and volume of cleaning fluid 162 sprayed onto the nozzle plate 49. By using the compliant tubing 230 as a reservoir for storing the fluid pressure energy, this configuration allows a lower capacity and lower cost pump to be used to supply the cleaning fluid 162 to the spraying system 160. The compliance of tubing 230 also damps out any water hammer produced by the closing of the valve 228.

In some embodiments, a pulsation damper 240 is connected to the tubing 230 upstream of the valve 228 as an alternative to using compliant tubing 230, or in addition to using compliant tubing 230 to store the fluid pressure energy. Pulsation dampers 240 typically include a chamber in which a gas 242, such as air, is trapped that is Td into the fluid line. As the fluid pressure rises, the gas 242 in the chamber is compressed to store fluid pressure energy. While it is advantageous to use compliant tubing 230 between the pump 154 and the valve 228 to store the fluid pressure energy, the tubing 232 between the valve 228 and the spraying system 160 is preferably not compliant to avoid dampening out the pressure pulse as it passes through tubing 232 upon opening the valve 228. It is therefore preferable for the tubing 232 to be made of a non-compliant material and for the length of tubing 232 to be kept as short as possible.

After the cleaning fluid 162 is sprayed through the outlet openings 176, 210 onto the nozzle plate 49, it flows down into the sump 142. A supply of cleaning fluid 162 is retained in the sump 142 to clean the 202a, 202b as they rotate through the cleaning fluid 162 as was discussed earlier. Excess cleaning fluid 162 can drain out of the sump 142 through ports 144a, 144b and drain line 238 into a waste receptacle 234.

While the cleaning process parameters can be varied to accommodate different ink compositions and nozzle plate constructions, in a preferred embodiment, the cleaning process takes about two minutes and involves 10-12 revolutions of the rotating wiper assembly 190. Cleaning fluid is sprayed at the nozzle plate for about two seconds during each revolution of the rotating wiper assembly. An exemplary cleaning fluid is disclosed in commonly-assigned U.S. Pat. No. 8,764,161 to Cook, et al.

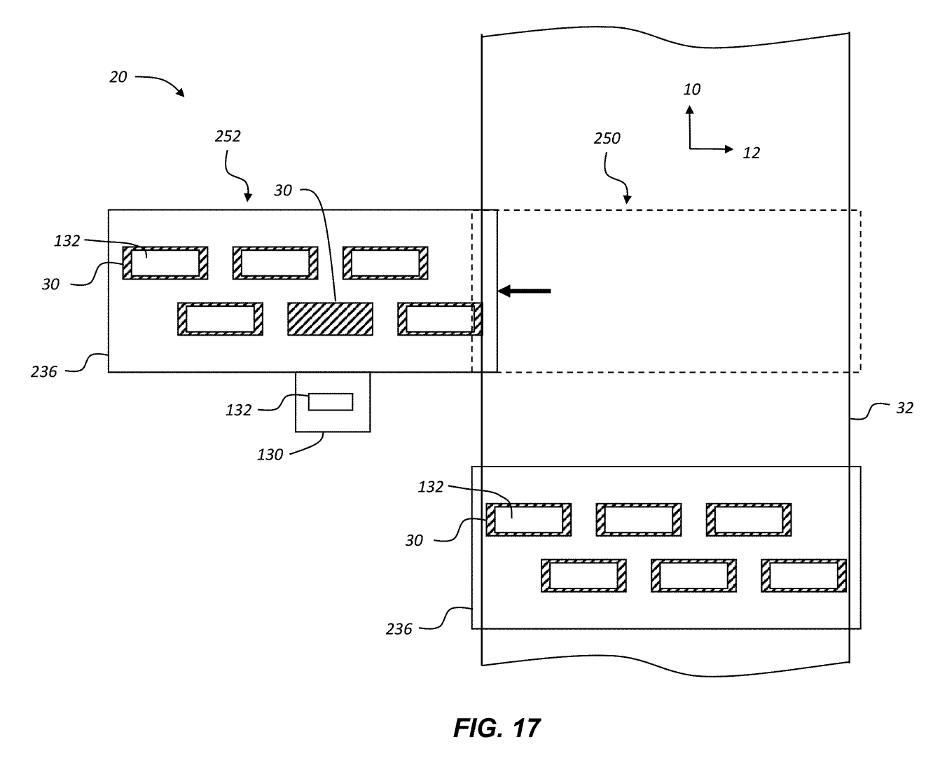

While the cleaning system 130 is effective for cleaning individual jetting modules 132 that have been removed from a printing system 20, the cleaning system 130 can be also used synergistically with the maintenance operations of the printing system 20 to enhance the cleaning process. FIG. 17 shows a schematic plan view of a portion of a printing system 20. While printing, one or more lineheads 236 are positioned over the print medium 32 as the print medium 32 travels through the printing system 20 in an in-track direction 10. The lineheads 236 typically span the width of the print medium 32 in the cross-track and include a plurality of printheads 30. The printheads 30 each include a jetting module 132. Each jetting module 132 is connected electronically to control circuits 26 (not shown in FIG. 17) by means of one or more associated electronic cables. Each jetting module 132 is also fluidically to the fluid system 39 (not shown in FIG. 17) via one or more associated flexible fluid lines.

In FIG. 17, one of the lineheads 236 has been moved from its printing position 250 over the print medium 32 to a service position 252 displaced in the cross-track direction 12 to the side of the print medium 32. The fluid system 39 associated with the jetting module 132 is deactivated so that it is not pumping fluid to the jetting module 132. The mechanical latch holding the jetting module 132 in the printhead 30 can be released to allow the jetting module 132 to be extracted from printhead 30. The jetting module 132 can then be mounted in the cleaning system 130. In a preferred configuration, the cleaning system 130 is positioned adjacent to the printhead 30 whose jetting module 132 is to be cleaned so that the jetting module 132 can be repositioned from the printhead 30 to the cleaning system 130 without disconnecting the electronic cables or the fluid lines from the jetting module 132. The cleaning system 130 can be used to service the jetting modules 132 in each of the printheads 30 in the linehead 236 one at a time. In some embodiments, the cleaning system 130 is removably attached to the printing system 20 so that it can be repositioned to be in proximity to the particular printhead 30 being serviced.

In a preferred arrangement, the cleaning system 130 is self-contained and removably attachable to the printing system 20 so that a service technician can carry it between different printing systems 20. In some cases, the cleaning system can utilize self-contained battery power sources so that it can be utilized without needing to connect it to an external power source. Appropriate electrical and/or fluid connections can be provided on the printing systems 20 to enable the cleaning system 130 to be quickly connected to the printing systems 20.

When the jetting module 132 has been mounted onto the cleaning system 130, the printing system operator can then have a controller (e.g., micro-controller 38 of FIG. 1) initiate various cleaning steps in conjunction with the operation of the cleaning system 130. These cleaning steps can include activating piezoelectric transducers attached to the jetting module 132 to ultrasonically vibrate the jetting module 132 and thereby dislodge particles from the surfaces of the jetting module 132 as disclosed in U.S. Pat. No. 4,563,688 to Braun. In some embodiments, the fluid system 39 of the printing system 20 is controlled to supply pressurized cleaning fluid 162 (or some other fluid such as ink) to the interior of the jetting module 132 such that fluid flows out of the array of nozzles 50 (FIG. 2) while the cleaning system 160 is being operated so that the wiper blades 202a, 202b are wiping debris from the nozzle plate 49. The outward flow of cleaning fluid 162 through the nozzles 50 can prevent debris from being swept into a nozzle 50 by the wiper blades 202a, 202b. At other times during a cleaning operation, the fluid system 39 of the printing system 20 can apply a vacuum to the interior of the jetting module 132 to cause cleaning fluid 162 sprayed onto the nozzle plate 49 by the cleaning system 130 to be ingested through the array of nozzles 50 to aid in dislodging debris from the interior of the nozzle plate 49. The controller can also apply pulses to the drop formation heaters 51 associated with the nozzles 50 at frequencies or amplitudes that enhance cleaning while the nozzle plate 49 is being sprayed or wiped, as disclosed in commonly-assigned U.S. Pat. No. 8,128,196 to Garbacz et al., which is incorporated herein by reference.

In some embodiments, the cleaning system 130 can be electronically coupled to the controller (e.g., micro-controller 38 of FIG. 1) so that the controller can independently control the operation the spraying system 160 and the rotating wiper mechanism 190 in conjunction with the various cleaning steps carried out by the printing system 20. In some embodiments, after a certain duration of spraying and wiping operations, the controller can discontinue the spraying operation and it can, using the fluid system 39 of the printing system 20, flush the cleaning fluid 162 from the jetting module 132 using a replenishment fluid or other fluid in preparation to again supply ink to the jetting module 132. During this flushing operation, the flushing fluid can flow out through the nozzles 50 to rinse the cleaning fluid 162 off the exterior of the nozzle plate 49. In this case, the rotating wiper mechanism 190 can be activated to wipe the flushing fluid off the nozzle plate 49. In some embodiments, the fluid system 39 of the printing system 20 provides the cleaning fluid 162 to the cleaning system 130, serving as the reservoir 184 for the cleaning system 130. In some embodiments, the ports 144a, 144b of the sump 142 are connected to a waste receptacle 234 of the printing system 20 so that the cleaning system 130 doesn't require a separate waste receptacle 234.

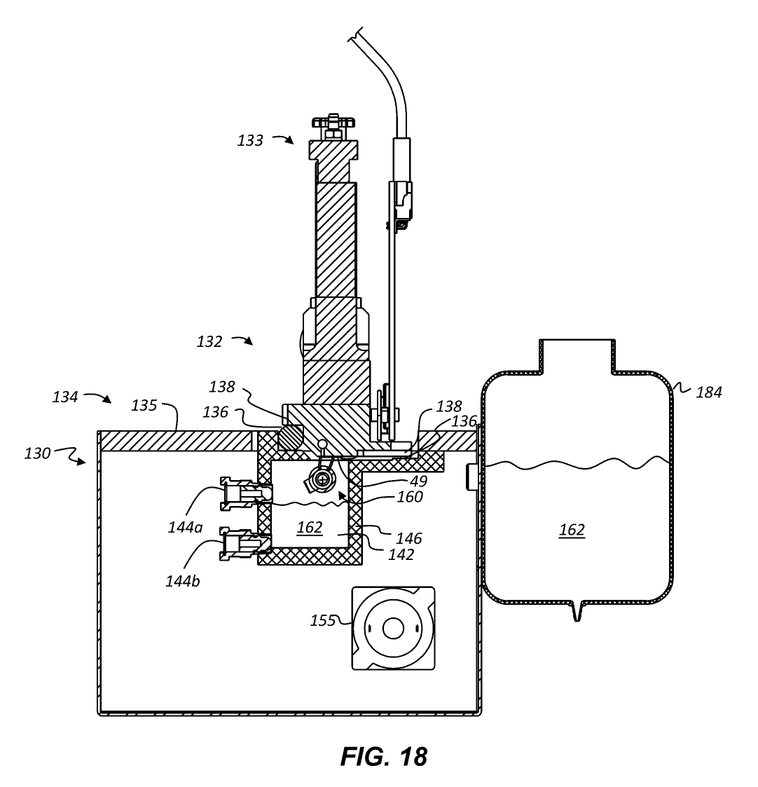

The mounting system used to mount the jetting module 132 to the cleaning system 130 can be adapted to whatever system is appropriate for a particular printing system 20. For example, FIG. 18 shows a cross-section view of embodiment of the invention in which the mounting system has been modified to accommodate a different style of jetting module 132. In this configuration, the jetting module 132 utilizes a mounting system similar to that described in commonly-assigned U.S. Pat. No. 9,623,689 to Piatt et al., which is incorporated herein by reference. As with the embodiments described earlier, the mounting plate 135 includes alignment features 136 analogous to those of the printhead that incorporates the jetting module 132. In this case, the alignment features 138 on the jetting module include alignment tabs adapted to engage with a rod. Therefore, to mount the jetting module 132 onto the cleaning system 130, the alignment features 136 of the cleaning system 130 include a similar rod that engages with the alignment tabs on the jetting module 132. The illustrated configuration also includes a fluid coupling assembly 133 which is latched to the jetting module 132 through which fluids can be supplied to the jetting module 132. In an exemplary arrangement, the fluid coupling assembly 133 can be of the type described in co-pending, commonly-assigned U.S. patent application Ser. No.______ (Docket K002169), to Piatt et al., entitled “Jetting module fluid coupling system,” which is incorporated herein by reference.

The invention has been described in detail with particular reference to certain preferred embodiments thereof, but it will be understood that variations and modifications can be effected within the spirit and scope of the invention.

### PARTS LIST

10 in-track direction

12 cross-track direction

20 printing system

22 image source

24 image processing unit

26 control circuits

27 synchronization device

28 drop forming transducer

30 printhead

32 print medium

34 print medium transport system

35 speed measurement device

36 media transport controller

38 micro-controller

39 fluid system

40 ink reservoir

44 ink recycling unit

46 ink pressure regulator

47 ink channel

48 jetting module

49 nozzle plate

50 nozzle

51 heater

52 liquid stream

54 drop

55 drop formation waveform source

57 trajectory

59 break off location

60 drop formation waveform

61 charging device

62 charging electrode

62′ charging electrode

63 charging electrode waveform source

64 charging electrode waveform

66 printing drop

68 non-printing drop

69 drop selection system

70 deflection mechanism

71 deflection electrode

72 ink catcher

74 catcher face

76 ink film

78 liquid channel

79 lower plate

80 charging electrode waveform period

82 first voltage state

84 second voltage state

86 non-print trajectory

88 print dot

92-1 drop formation waveform

92-2 drop formation waveform

92-3 drop formation waveform

94-1 drop formation waveform

94-2 drop formation waveform

94-3 drop formation waveform

94-4 drop formation waveform

96 period

98 pulse

100 period

102 pulse

104-1 large drop

104-2 large drop

104-3 large drop

106-1 small drop

106-2 small drop

106-3 small drop

106-4 small drop

108 phase shift

130 cleaning system

132 jetting module

133 fluid coupling assembly

134 mounting system

135 mounting plate

136 alignment feature

138 alignment feature

140 opening

142 sump

144a port

144b port

146 wall

148 side shield

150 magnet

152 sensor

154 pump

155 pump motor

160 spraying system

162 cleaning fluid

166 non-rotating shaft

168 hollow core

170 outer surface

172 shaft axis

174 nozzle array

176 outlet opening

178 flat face

180 hypodermic tubing

182 fluid source

184 reservoir

186 elongated slot

190 rotating wiper mechanism

192 rotating sleeve

194 sleeve axis

196 outer surface

198 inner surface

200 opening

202a wiper blade

202b wiper blade

204 counter-clockwise direction

206 leading edge

208 trailing edge

210 outlet opening

212 hypodermic tubing

215 actuator

216 motor

218 gears

220 roller

222 rubber rings

224 upper shield

228 valve

230 tubing

232 tubing

234 waste receptacle

236 linehead

238 drain line

240 pulsation damper

242 gas

250 printing position

252 service position

1. A jetting-module cleaning system for cleaning ink deposits from a nozzle plate of a jetting module of an inkjet printing system, the nozzle plate including an array of nozzles through which ink is ejected, the array of nozzles extending a length in a length direction, comprising:
a mounting system for mounting the jetting module in the jetting-module cleaning system;
a rotating wiper mechanism including:
a rotating sleeve which rotates around a sleeve axis, the rotating sleeve having a hollow core and an outer surface, the sleeve axis being parallel to the length direction of the nozzle array of a mounted jetting module, the rotating sleeve having a length which is at least as long as the length of the nozzle array, wherein the rotating sleeve includes a set of one or more outlet openings extending from the hollow core to the outer surface, the outlet openings being located at an angular position relative to the sleeve axis; and
one or more wiper blades affixed to the outer surface of the rotating sleeve at corresponding angular positions, the wiper blades extending the length of the nozzle array, wherein when the rotating sleeve is rotated the wiper blades wipe across the nozzle pate of the mounted jetting module;
an actuator for rotating the rotating wiper mechanism around the sleeve axis;
a pressurized fluid source for supplying pressurized cleaning fluid through tubing to the hollow core of the rotating sleeve; and
a valve adapted to control the flow of the cleaning fluid through the tubing between the pressurized fluid source and the hollow core of the rotating sleeve;
wherein when the rotating wiper mechanism is rotated to an angular orientation where the one or more outlet openings in the rotating sleeve face the nozzle plate the valve is controlled to enable the flow of the cleaning fluid through the tubing so that the cleaning fluid is sprayed onto the nozzle plate, and when the rotating wiper mechanism is rotated to an angular orientation where the one or more outlet openings in the rotating sleeve do not face the nozzle plate the valve is controlled to block the flow of the cleaning fluid through the tubing.

2. The jetting-module cleaning system of claim 1, wherein the one or more wiper blades include a leading wiper blade affixed to the hollow rotating sleeve at an angular position preceding the angular position of the one or more outlet openings in the hollow rotating sleeve and a trailing wiper blade affixed to the hollow rotating sleeve at an angular position following the angular position of the one or more outlet openings in the hollow rotating sleeve.

3. The jetting-module cleaning system of claim 2, wherein the leading wiper blade is shorter or thinner than the trailing wiper blade.

4. The jetting-module cleaning system of claim 2, wherein the leading wiper blade is made of a material having a lower durometer than the trailing wiper blade.

5. The jetting-module cleaning system of claim 1, the one or more wiper blades are elastomeric.

6. The jetting-module cleaning system of claim 1, wherein the one or more outlet openings in the rotating sleeve include a plurality of nozzles distributed along the length of the rotating sleeve.

7. The jetting-module cleaning system of claim 1, wherein the one or more outlet openings in the rotating sleeve include a slot extending over at least the length of the nozzle array.

8. The jetting-module cleaning system of claim 1, wherein the mounting system includes alignment features which engage with corresponding alignment features on the jetting module.

9. The jetting-module cleaning system of claim 1, wherein the pressurized fluid source includes a pump.

10. The jetting-module cleaning system of claim 9, wherein the pump is a peristaltic pump.

11. The jetting-module cleaning system of claim 9, wherein the actuator that rotates the rotating wiper mechanism is a motor, and wherein the motor also drives the pump.

12. The jetting-module cleaning system of claim 9, wherein the tubing between the pump and the valve is made of a compliant material such that the tubing between the pump and the valve expands when the flow of cleaning fluid is blocked.

13. The jetting-module cleaning system of claim 1, further including a sensor for sensing a rotational position of the rotating wiper mechanism, wherein the valve is controlled responsive to the sensed rotational position of the rotating wiper mechanism.

14. The jetting-module cleaning system of claim 1, further including a sump that encloses the rotating wiper mechanism, the sump being adapted to collect the cleaning fluid that is sprayed onto the nozzle plate.

15. The jetting-module cleaning system of claim 14, wherein the one or more wiper blades pass through cleaning fluid collected in the sump as the rotating wiper mechanism rotates.

16. The jetting-module cleaning system of claim 1, wherein the jetting-module cleaning system is positioned in proximity to an inkjet printing system such that the jetting module can be moved from a printing position in the inkjet printing system to be mounted in the jetting-module cleaning system without disconnecting associated fluid lines or electrical connection from the jetting module.

17. The jetting-module cleaning system of claim 16, wherein the jetting-module cleaning system is removably attached to the inkjet printing system.

18. The jetting-module cleaning system of claim 1, wherein the array of nozzles is a linear nozzle array.

19. The jetting-module cleaning system of claim 1, wherein the rotating sleeve further includes a second set of one or more outlet openings extending from the hollow core to the outer surface, the second set of one or more outlet openings being located at a second angular position relative to the sleeve axis.

20. The jetting-module cleaning system of claim 1, wherein the jetting module is controlled to eject a liquid from the nozzles while it is being cleaned in the jetting-module cleaning system.
